(19) United States
(12) Patent Application Publication
(10) Pub. No.: US 2026/0134732 A1
(43) Pub. Date: May 14, 2026

(54) COLLAPSIBLE BALLOT BOX

(71) Applicant: Clear Ballot Group, Inc., Boston, MA (US)

(72) Inventors: Adam Meunier, Cumberland, RI (US); Michael Papa, Windham, NH (US); Savio Polini, Boston, MA (US)

(21) Appl. No.: 18/943,393

(22) Filed: Nov. 11, 2024

(51) Int. Cl. G07C 13/02; A45C 5/14; A45C 7/00; A45C 13/02; A45C 13/10

(52) U.S. Cl. CPC G07C 13/02; A45C 5/14; A45C 7/0036; A45C 13/02; A45C 13/103; A45C 13/1046; A45C 2013/026; A45C 2013/1015

(57) ABSTRACT

A ballot box according to an embodiment comprises first and second side walls with rigid frames. Collapsible front, rear, and bottom panels are provided that extend between the side walls. A top panel is provided that includes a flexible top panel layer and a rigid top panel layer secured to the flexible top panel layer, and it includes an aperture shaped to receive ballots. The flexible top panel layer is releasably securable across the top of the ballot box, and, when the flexible top layer is secured across the top perimeter, the rigid top panel layer is configured to rest on top of the first and second side walls.

### BACKGROUND

The present disclosure relates to features of a ballot box. In particular, the disclosure relates to a collapsible ballot box that allows for more convenient transport, setup, and storage.

In the development of voting technologies, concerns of accessibility, accuracy, reliability, and auditability are of paramount importance. The Voluntary Voting System Guidelines (VVSG) provides a set of guidelines for voting systems to provide desired levels of functionality, accessibility, and security. Included in the VVSG are guidelines for ensuring that an error or fault in the voting system software or hardware cannot cause an undetectable change in election results. According to one such guideline, paper ballots may be provided with a unique identifier that allows auditors to uniquely address individual ballots while the voter who cast the ballot remains anonymous. Aside from the goals of the VVSG, organizing elections also involves the challenges of transporting, setting up, operating, and taking down a large amount of equipment in a relatively short amount of time, and that equipment may need to be stored for much of the year. Thus, it is desirable to provide voting equipment that not only provides confidence in the outcome of an election, but that also employs technologies that simplify the logistical and operational aspects of implementing elections. Given the goal of providing election equipment that is capable of being used by different voters with different physical capabilities in different jurisdictions with different election regulations, it is particularly challenging to develop equipment capable of satisfying these different requirements while also allowing for convenient transport, setup, and storage.

### SUMMARY

A ballot box apparatus according to some embodiments comprises: a first side wall and a second side wall, each of the first and second side walls having a rigid frame; a collapsible front panel, a collapsible rear panel, and a collapsible bottom panel extending between corresponding edges of the first and second side walls, the side walls and the front and rear panels defining a ballot box interior; a top panel, the top panel including a flexible top panel layer and a rigid top panel layer secured to the flexible top panel layer, the top panel including an aperture shaped to receive ballots; wherein the flexible top panel layer is releasably securable across a top perimeter between top edges of the first and second side walls and of the front and rear panels, and wherein, when the flexible top layer is secured across the top perimeter, the rigid top panel layer is configured to rest on top of the first and second side walls.

In some embodiments, the rigid top panel layer includes flanges that laterally engage the first and second side walls to prevent lateral movement of the rigid top panel layer.

In some embodiments, the flexible top panel layer is releasably securable across the top perimeter using a zipper.

Some embodiments further comprise at least one first strip of hook-and-loop fastener around an interior perimeter of the ballot box interior.

Some embodiments further comprise a ballot bag, the ballot bag having at least one second strip of hook-and-loop fastener around a perimeter thereof, the second strip being engageable with the first strip when the ballot bag is in the ballot box interior.

In some embodiments, the ballot bag has a closeable top, and wherein the second strip is interior to the closeable top such that the first strip is engageable with the second strip only when the closeable top is open.

Some embodiments further comprise a plurality of extendable connectors between the first side wall and the second side wall, the extendable connectors being moveable between a collapsed configuration in which the first and second side walls are held together and an expanded configuration in which the first and second side walls are held apart.

In some embodiments, the rigid top panel layer is configured to support a tabulator apparatus.

In some embodiments, the rigid top panel layer is configured to interlock with a tabulator apparatus.

In some embodiments, the rigid top panel layer includes a hinged locking plate configured to interlock with a tabulator apparatus.

In some embodiments, the rigid top panel layer comprises a metal plate extending between the first and second walls.

In some embodiments, the rigid top panel layer is riveted to a top surface of the flexible top panel layer.

A method of setting up a ballot box according to some embodiments comprises: separating a first side wall and a second side wall of a ballot box to expand the ballot box from a collapsed configuration to an expanded configuration in which a collapsible front panel, a collapsible rear panel, and a collapsible bottom panel extend between corresponding edges of the first and second side walls; releasably securing a top panel across a top perimeter between top edges of the first and second side walls and of the front and rear panels, wherein the top panel includes a flexible top panel layer and a rigid top panel layer secured to the flexible top panel layer; and positioning the rigid top panel layer to rest on top of the first and second side walls.

Some embodiments further comprise positioning flanges of the rigid top layer to laterally engage the first and second side walls.

In some embodiments, the flexible top panel layer is releasably secured across the top perimeter using a zipper.

Some embodiments further comprise deploying a ballot bag in the ballot box, e.g. using at least one strip of hook-and-loop fastener.

Some embodiments further comprise affixing a tabulator apparatus to the rigid top panel layer.

In some embodiments, the rigid top panel layer includes a hinged locking plate, and affixing the tabulator apparatus comprises interlocking the tabulator apparatus with the hinged locking plate.

In some embodiments, the top panel includes an aperture, the tabulator includes at least one tab on a bottom surface thereof, and affixing the tabulator comprises engaging the tab in the aperture.

### BRIEF DESCRIPTION OF THE DRAWINGS

FIG. 1 is a perspective illustration of a collapsible ballot box in the process of being expanded according to some embodiments.

FIG. 2 is a perspective illustration of a collapsible ballot box in the process of preparing a top panel to be secured according to some embodiments.

FIG. 3 is a perspective illustration of a collapsible ballot box with the top panel in a secured position according to some embodiments.

FIG. 4 is a perspective illustration of a ballot bag being deployed in a collapsible ballot box according to some embodiments.

FIG. 5 is a schematic cross-sectional view of a ballot bag according to some embodiments.

FIG. 6 is a schematic cross-sectional view of a ballot bag deployed in a ballot box according to some embodiments.

FIG. 7 is a perspective illustration of a ballot bag being removed from a ballot box according to some embodiments.

FIG. 8 is a close-up perspective illustration of a security zipper in a locked configuration as used in some embodiments.

FIG. 9 is a perspective illustration of a rigid top panel layer according to some embodiments.

FIG. 10 is a schematic cross-sectional view of a tabulator apparatus in a position for engagement with the rigid top panel layer according to some embodiments.

FIG. 11 is a schematic cross-sectional view of the tabulator apparatus after engagement with the rigid top panel layer.

FIG. 12 is a perspective view of the tabulator apparatus being seated on the rigid top panel layer of the ballot box according to some embodiments.

FIG. 13 is a close-up perspective view of the tabulator apparatus being latched to the hinged attachment of the rigid top panel layer according to some embodiments.

FIG. 14 is a close-up perspective view of the tabulator apparatus being secured to the hinged attachment of the rigid top panel layer according to some embodiments.

FIG. 15 is a close-up perspective view of a tabulator apparatus being secured to the hinged attachment of the rigid top panel layer according to an additional embodiment.

FIG. 16 is a perspective view of the interior of a ballot box during a setup process according to some embodiments.

### DETAILED DESCRIPTION

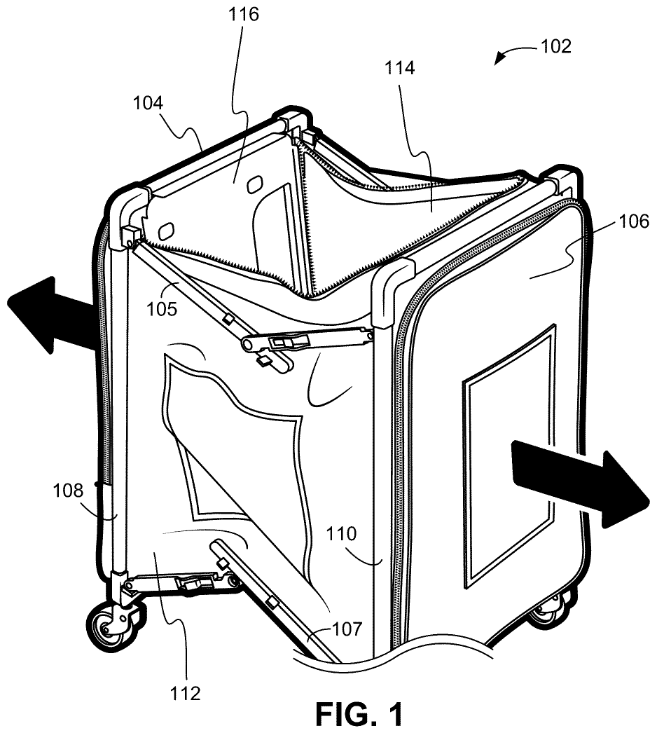

FIG. 1 is a perspective view of a collapsible ballot box apparatus 102 according to some embodiments. In FIG. 1, the ballot box is shown in the process of being expanded from a collapsed configuration into an expanded configuration. In this example, the ballot box includes a first side wall 104 and a second side wall 106. Each of the first and second side walls have a rigid frame, as illustrated for example by frame members 108, 110.

The ballot box further includes a collapsible front panel 112 and a collapsible rear panel 114. A collapsible bottom panel (see panel 1602 of FIG. 16) extends between corresponding bottom edges of the first and second side walls. Together, the side walls and the front and rear panels define an interior space of the ballot box. A top panel 116, partially visible in FIG. 1, is in an undeployed position within the ballot box interior, where it may be kept for storage while the ballot box is in a collapsed configuration.

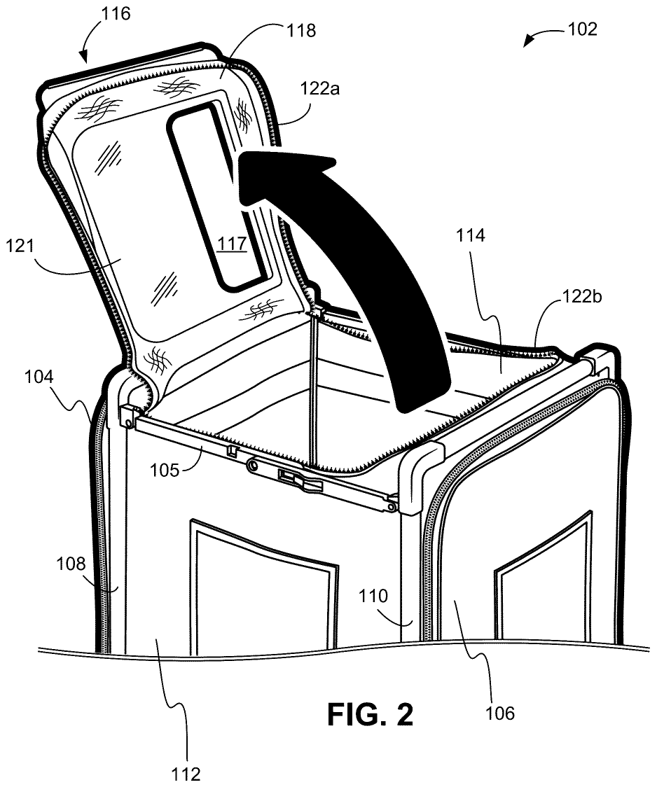

FIG. 2 is another perspective view of ballot box 102, in which the ballot box is in the fully expanded configuration. In the view of FIG. 2, the top panel 116 has been flipped open and out of the ballot box interior. The top panel including an aperture 117 shaped to receive ballots.

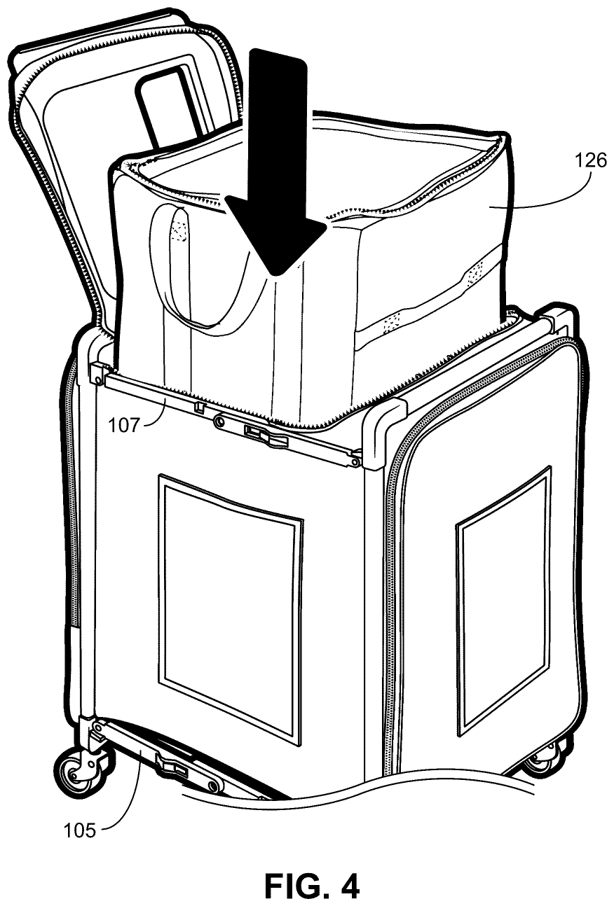

In some embodiments, the ballot box 102 includes extendable connectors such as hinged connectors 105, 107 between the first side wall and the second side wall. The extendable connectors may be moveable between a collapsed configuration in which the first and second side walls are held together and an expanded configuration, seen in FIG. 2 (and FIG. 4, described below), in which the first and second side walls are held apart.

In an example embodiment, the top panel 116 includes both a flexible top panel layer 118 and a rigid top panel layer 120. In some embodiments, the flexible top panel layer is made of a canvas or other woven material, although different materials may be used in other embodiments. In some embodiments, the rigid top panel layer 120 is made of metal, such as steel, but other metallic or non-metallic materials may be used in other embodiments.

As seen in FIG. 2, the top edges of the first and second side walls and the front and rear panels form a top perimeter, and the flexible top panel layer 118 is releasably securable across that top perimeter. As used herein, the top panel is considered to be releasable even if it is not entirely removable from the rest of the ballot box. To illustrate, in the example of FIG. 2, one edge of the top panel may be permanently attached to (or in some embodiments, contiguous with) the first side wall 104 to provide a hinge effect.

In some embodiments, the flexible top panel layer is releasably securable across the top perimeter using a zipper, such as the complementary zipper segments 122a, 122b illustrated in FIG. 2.

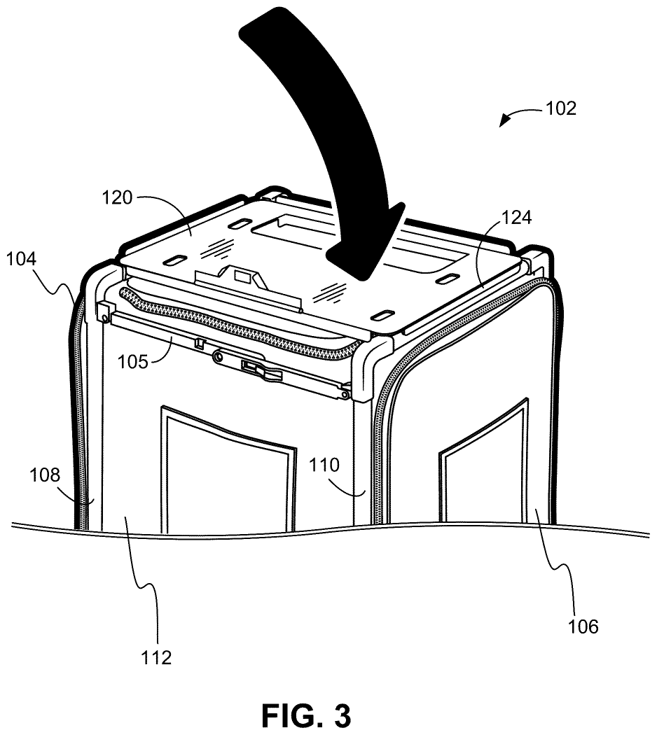

FIG. 3 illustrates a configuration in which the flexible top panel layer has been secured across the top perimeter. In the configuration of FIG. 3, the rigid top panel layer 120 rests on top of the first and second side walls 104, 106. In this way, the rigid frames of the side walls, together with the rigid top panel layer 120, form a sturdy support surface. As described in further detail below, the support surface may be used in some embodiments to support a tabulator apparatus.

In the example of FIG. 3, the rigid top panel layer 120 includes flanges such as flange 124 that laterally engage the first and second side walls to prevent lateral movement of the rigid top panel layer.

In some embodiments, as illustrated in FIG. 4, a ballot bag 126 may be deployed in the ballot box 102, for example by inserting it through the top before the top panel is closed.

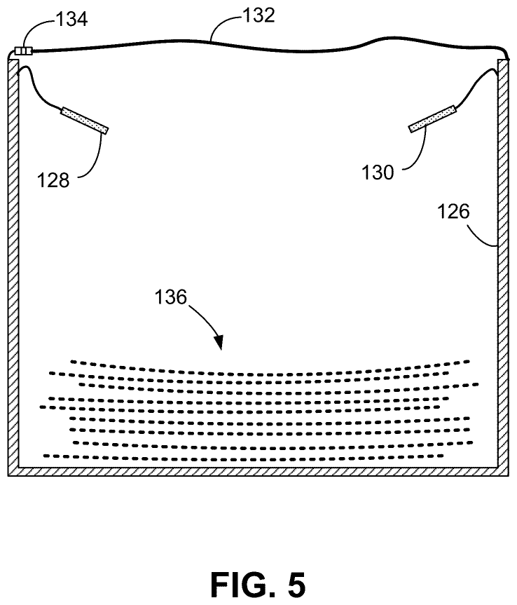

FIG. 5 is a cross-sectional schematic view illustrating features of a ballot bag 126. The ballot bag in this embodiment has at least one strip of hook-and-loop fastener, e.g. strips 128, 130, around at least a portion of a perimeter of the ballot bag. The strips of hook-and-loop fastener of the ballot bag may be engageable with complementary strips of hook-and-loop fastener on the interior of the ballot box, as described in further detail below. In this example, the ballot bag 126 has a closeable top 132, which may be a flexible (e.g. canvas) top that may be securable using a zipper fastener 134. The zipper fastener may be a security zipper that is sealable to allow for secure transport of completed ballots 136. As shown in the example of FIG. 5, the strips of hook-and-loop fastener of the ballot bag are interior to the closeable top 132.

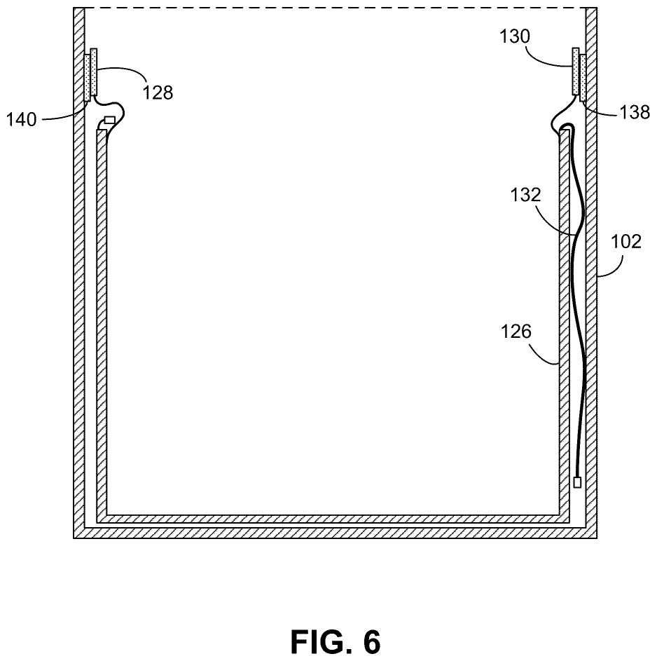

To deploy the ballot bag, before it has been used to collect ballots, the ballot bag may be secured inside the ballot box using features as illustrated schematically in FIG. 6. The closeable top 132 of the ballot bag 126 is opened (e.g. unzipped), and the strips 128, 130 of hook-and-loop fastener that were interior to the closeable top 132 are extended from the interior and engage with complementary strips 138, 140 that are arranged around an interior perimeter of the ballot box 102. In this embodiment, the strips withing the ballot bag are engageable with the complementary strips inside the ballot box only when the closeable top 132 is open. This helps to ensure proper operation of the ballot bag together with the ballot box, for example a poll worker may be alerted to the fact that the ballot bag is not fully open if the complementary strips do not correctly engage. Moreover, the attachment of complementary strips from the inside of the ballot bag 126 to the interior perimeter of the ballot box 102 ensures that ballots cannot be inadvertently deposited between the ballot bag and the ballot box.

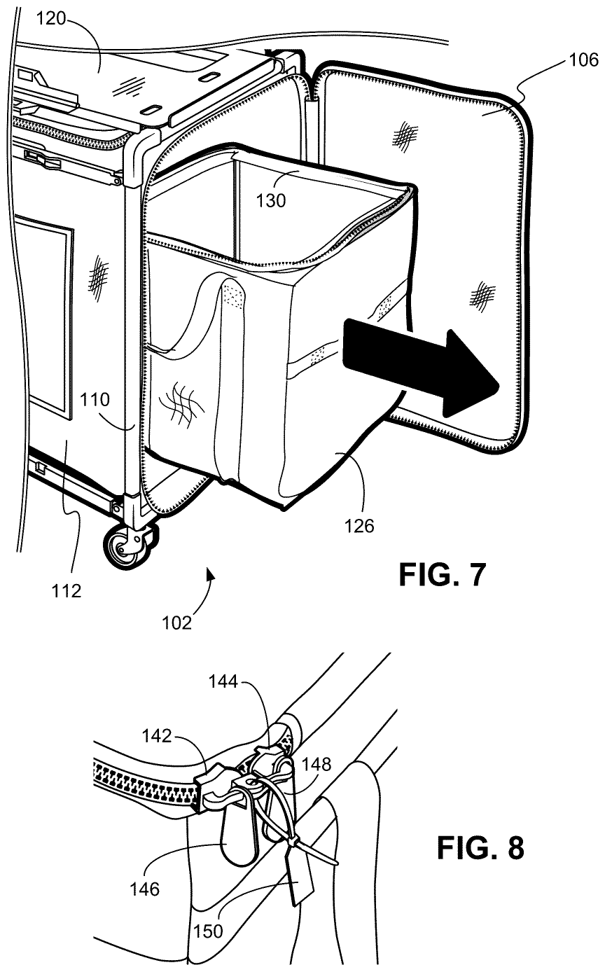

In some embodiments, one or more of the front, back, or side walls may be entirely or partly openable to allow for removal of the ballot bag 126 from the ballot box 102. For example, as illustrated in FIG. 7, a portion of the second side wall 106 is openable using a zipper (e.g. a security zipper) to allow for removal of the ballot bag 126. Such a side opening allows for removal of the ballot bag without the need to lift the ballot bag (which may be much heavier after ballots are deposited) out of the top opening and without the need to remove any tabulator or other apparatus that may be supported on the top surface. Such a side opening further allows for easier inspection to ensure that no ballots remain in the ballot box after the ballot bag is removed for transport.

Some or all of the zippers used in example embodiments may be security zippers that are resistant to tampering. Some or all of the zipper fasteners described herein may use two sliders, such as sliders 142, 144 shown in FIG. 8, that close the zipper as they are brought into proximity. The sliders and/or corresponding pulls 146, 148 may include apertures or other features that allow for the zipper to be held in a closed position by a lock and/or a seal, such as seal 150. In some embodiments, the ballot box and/or the ballot bag on which a zipper is used may include one or more tabs, loops, grommets, or similar features through which the lock and/or seal may also be threaded or otherwise passed to further secure the zipper closure.

The ballot box side walls 104, 106 have been described herein as having a rigid frame in at least some embodiments. This rigidity may be provided using different techniques in different embodiments. In some embodiments, the entire side wall is made of a rigid material. In other embodiments, as illustrated for example in FIG. 1, the side wall may be made partly of a rigid material and partly of a flexible material, for example, as illustrated in FIG. 1, the side wall may have a perimeter frame including rigid components such as frame members 108, 110, while other portions of the side wall are made of a flexible material such as canvas. In some embodiments, the frame members may be made of tubing, such as an aluminum or steel tubing. However, in other embodiments, other components may be used to provide the desired rigidity, including solid or laminated sheet materials such as laminated foam core panels or corrugated plastic panels.

In an example embodiment, the side walls together have sufficient rigidity to support a device such as a tabulator placed or mounted on the top panel.

In some embodiments, the rigid top panel layer 120 is configured to interlock with a tabulator apparatus. An example of one embodiment of such a configuration is described with reference to the following figures.

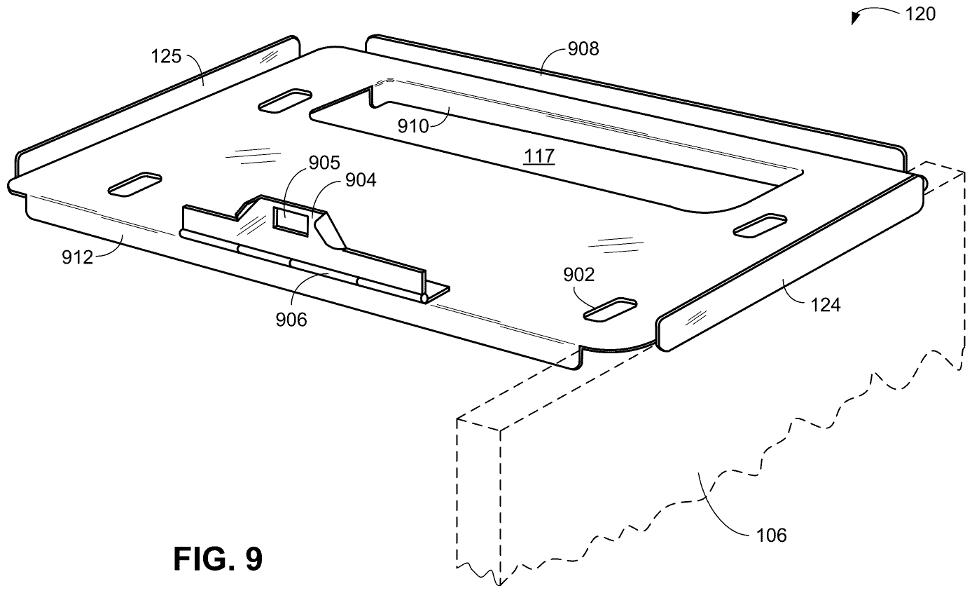

FIG. 9 is a perspective view of an example rigid top panel layer 120 according to an example embodiment. For the sake of clarity, the rigid top panel layer 120 in FIG. 9 is shown apart from other components of the ballot box. However, the side wall 106 is shown schematically in ghost lines to demonstrate how the rigid top panel layer 120 may rest securely on top of the side walls. The rigid top panel layer 120 includes the aperture 117 that is shaped to receive ballots (e.g. it is sufficiently large to accommodate the passage of ballots). Additional apertures such as aperture 902 may be provided for other reasons, for example, to accommodate feet or other projections of a tabulator device. The rigid top panel layer 120 includes side flanges such as flanges 124 and 125 that laterally engage the side walls to prevent lateral movement of the rigid top panel layer (e.g. by preventing sliding of the rigid top panel layer). In some embodiments, a portion of these flanges may extend upward to provide additional structural strength and to guide the proper placement of a tabulator or other apparatus.

Additional flanges such as flanges 908, 910, 912, may be provided for various purposes, such as contributing to the lateral stability, increasing bending resistance, or guiding the placement of a tabulator or other apparatus. Upward-extending portions of these flanges, together with upward-extending portions of flanges 124 and 125 around the perimeter of the rigid to panel layer, also prevent attempts to add ballots improperly to the ballot box, e.g. they prevent ballots from being slid between the tabulator and the top panel layer into the aperture 117. In some embodiments, the main body of the rigid top panel layer is formed from a metal plate. The various flanges may be formed by bending the metal plate, or by welding, brazing, screwing, bolting, riveting, or otherwise adhering additional material, or by some combination of these or other techniques.

In some embodiments, the rigid top panel layer is riveted to a surface (e.g. a top surface) of the flexible top panel layer, though other attachment techniques such as screws, bolts, adhesives, welds, and the like may alternatively be used. In some embodiments the rigid top panel layer 120 is secured to the flexible to panel layer 118 with the assistance of a backing layer 121 (visible in FIG. 2). For example, the flexible layer may be sandwiched between the rigid layer and the backing layer, with rivets, bolts, or other connectors securing the rigid top panel layer to the backing layer through the flexible layer. In this example, the flexible layer 118, the rigid layer 120, and the backing layer 121 are all parts of the top panel 116.

In the example of FIG. 9, the rigid top panel layer 120 includes a locking plate 904 with an aperture 905 and a hinged attachment 906 to the main body of the rigid top panel layer. As discussed in greater detail below, this locking plate may be configured to interlock with a tabulator apparatus.

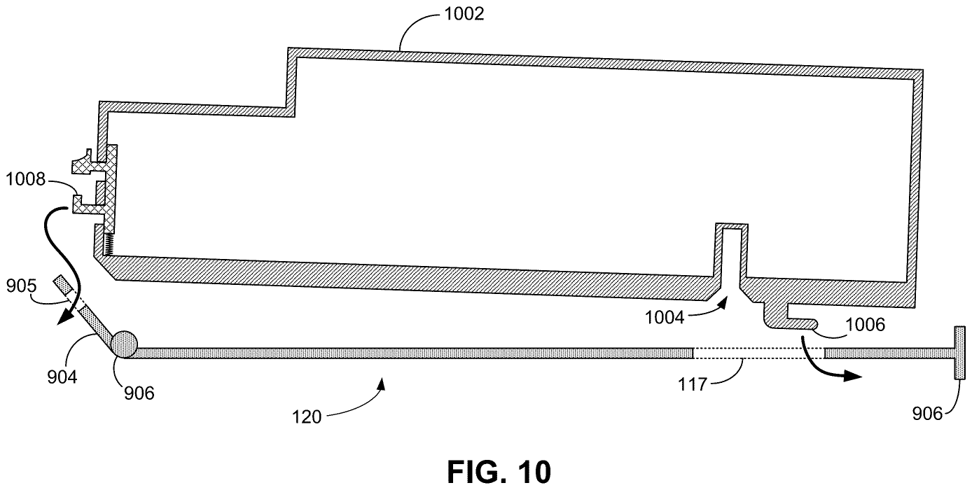

FIG. 10 is a schematic cross-sectional view of a tabulator apparatus 1002 in a position for engagement with the rigid top panel layer 120. For the sake of clarity, internal components of the tabulator 1002 are not illustrated. The tabulator 1002 includes a paper output slot 1004 out of which ballots may be ejected from the tabulator 1002 through the aperture 117 and into the ballot box. One or more locking tabs 1006 are provided on a bottom surface of the tabulator 1002 and are configured to engage the rigid top panel layer 120, e.g. by passing through the aperture 117 and engaging the bottom surface of the rigid top panel layer 120 (though other embodiments may employ other types of engagement, e.g. through different apertures or projections). The tabulator in this example further includes a moveable detent 1008 configured to engage the aperture 905 through the hinged attachment 906.

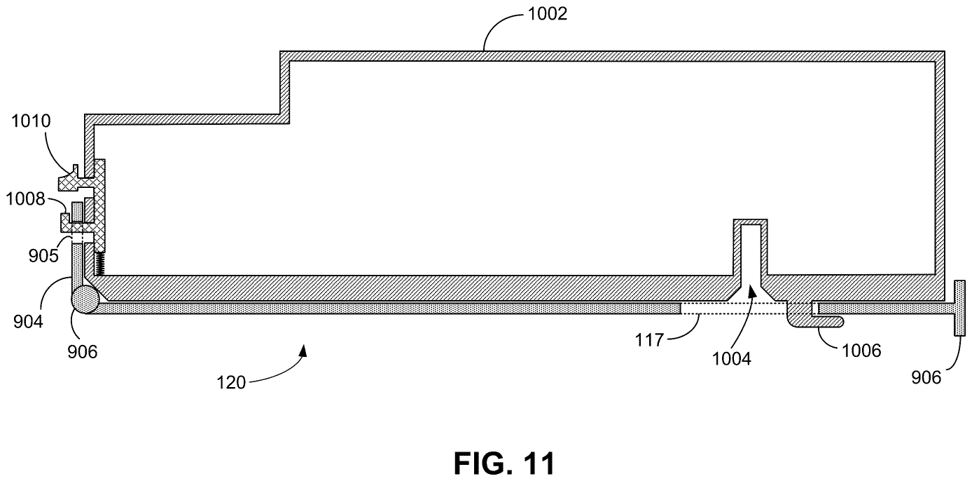

FIG. 11 is a schematic cross-sectional view of the tabulator apparatus 1002 after engagement with the rigid top panel layer 120. In some embodiments, as illustrated in FIG. 11, a button 1010 or similar mechanism may be provided to assist in moving the detent 1008 downward to allow for engagement of the detent with the aperture 905.

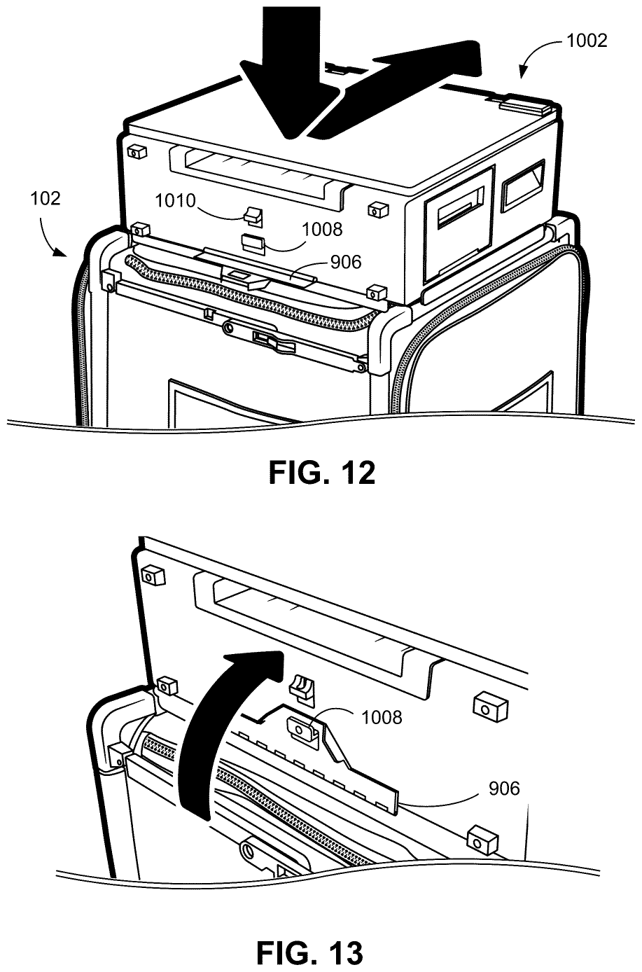

FIG. 12 is a perspective view of the tabulator apparatus 1002 being seated on the rigid top panel layer of the ballot box 102. In the configuration of FIG. 12, the hinged attachment 906 is not yet engaged with the tabulator.

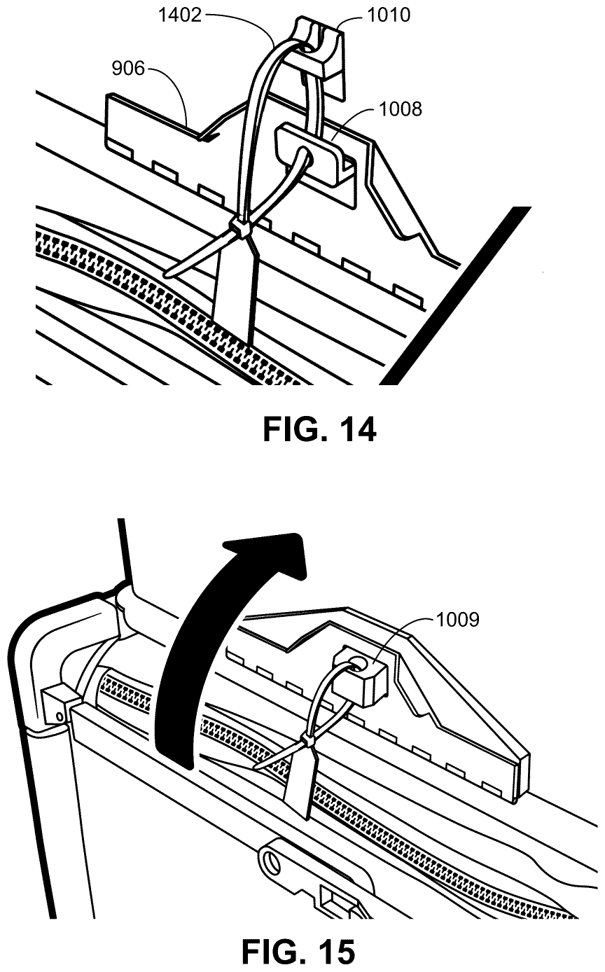

FIG. 13 is a perspective view of the tabulator apparatus 1002 being latched to the hinged attachment 906 of the rigid top panel layer. As seen in FIG. 14, one or both of the button mechanism 1010 and the detent 1008 may include an aperture to accept a lock or seal 1402. Together with other locks and/or seals on the ballot box apparatus (e.g. on security zippers), lock or seal 1402 helps to ensure that the only ballots inserted in the ballot box are those that have been properly processed by the tabulator and deposited through the paper output slot 1004.

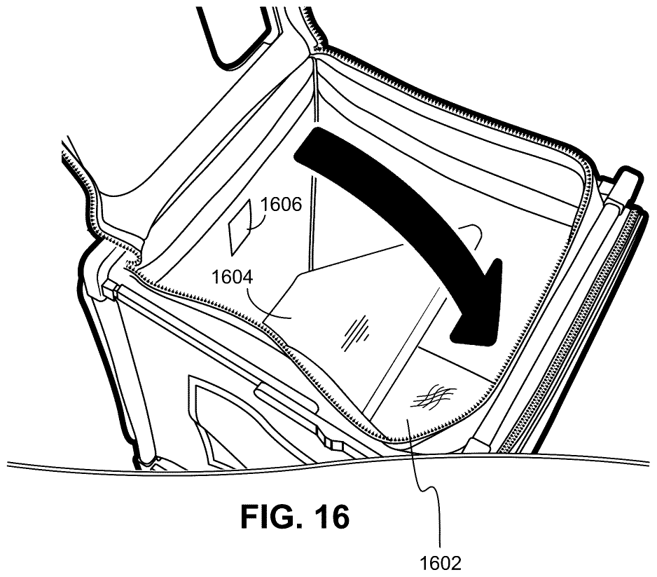

The rigid top panel layer may be configured to allow engagement with various different types of tabulator devices. As an example, FIG. 15 illustrates an engagement of the hinged attachment 906 with a tabulator having a fixed detent 1009. Other features may accommodate other variations in tabulator devices. For example, a tabulator device having a rearward-directed paper output slot may engage with the rigid top panel layer through a ballot adapter that directs ballots from the tabulator output slot through the aperture 117.

In an example method of setting up a ballot box, with reference to FIG. 1, a first side wall 104 and a second side wall 106 of a ballot box 102 are separated to expand the ballot box from a collapsed configuration to an expanded configuration in which a collapsible front panel 112, a collapsible rear panel 114, and a collapsible bottom panel extend between corresponding edges of the first and second side walls. FIG. 16 is a perspective view illustrating the collapsible bottom panel 1602 in an expanded configuration. In some embodiments, setup of the ballot box further includes deploying a rigid bottom panel 1604, which may be hinged to a bottom edge of one of the side walls. In the collapsed position, the rigid bottom panel 1604 may be releasably secured against one of the side walls 104 or 106 using a hook-and-loop type material 1606 or other type of fastener to prevent the rigid bottom panel 1604 from dropping down at an inopportune time. The example setup process further includes releasably securing a top panel 116 across a top perimeter between top edges of the first and second side walls and of the front and rear panels. As described above, in this example, the top panel includes a flexible top panel layer 118 and a rigid top panel layer 120 secured to the flexible top panel layer. The flexible top panel layer may be releasably secured across the top perimeter using a zipper. The rigid top panel layer 120 in this example is then positioned to rest on top of the first and second side walls. This may include positioning flanges of the rigid top layer to laterally engage the first and second side walls.

In some embodiments, the setup further includes deploying a ballot bag in the ballot box, as illustrated in FIG. 4. In some embodiments, this includes securing the ballot bag inside the ballot box using at least one strip of hook-and-loop fastener.

Some embodiments further include affixing a tabulator apparatus to the rigid top panel layer, as illustrated in FIGS. 10-15. In some such embodiments, as described above, the method includes interlocking the tabulator apparatus with a hinged locking plate. In some embodiments, the tabulator includes at least one tab 1002 on a bottom surface thereof, and affixing the tabulator comprises engaging the tab in the aperture 117 of the top panel.

While the present disclosure has described various embodiments and features for the purposes of illustration, it should be noted that the invention is not limited by those features, but rather extends to the full scope of the appended claims.

1. A ballot box apparatus comprising:
a first side wall and a second side wall, each of the first and second side walls having a rigid frame;
a collapsible front panel, a collapsible rear panel, and a collapsible bottom panel extending between corresponding edges of the first and second side walls;
a top panel, the top panel including a flexible top panel layer and a rigid top panel layer secured to the flexible top panel layer, the top panel including an aperture shaped to receive ballots;
wherein the flexible top panel layer is releasably securable across a top perimeter between top edges of the first and second side walls and of the front and rear panels, and wherein, when the flexible top layer is secured across the top perimeter, the rigid top panel layer is configured to rest on top of the first and second side walls.

2. The apparatus of claim 1, wherein the rigid top panel layer includes flanges that laterally engage the first and second side walls to prevent lateral movement of the rigid top panel layer.

3. The apparatus of claim 1, wherein the flexible top panel layer is releasably securable across the top perimeter using a zipper.

4. The apparatus of claim 1, further comprising at least one first strip of hook-and-loop fastener around an interior perimeter of the ballot box.

5. The apparatus of claim 4, further comprising a ballot bag, the ballot bag having at least one second strip of hook-and-loop fastener around a perimeter thereof, the second strip being engageable with the first strip when the ballot bag is inside the ballot box.

6. The apparatus of claim 5, wherein the ballot bag has a closeable top, and wherein the second strip is interior to the closeable top such that the first strip is engageable with the second strip only when the closeable top is open.

7. The apparatus of claim 1, further comprising a plurality of extendable connectors between the first side wall and the second side wall, the extendable connectors being moveable between a collapsed configuration in which the first and second side walls are held together and an expanded configuration in which the first and second side walls are held apart.

8. The apparatus of claim 1, wherein the rigid top panel layer is configured to support a tabulator apparatus.

9. The apparatus of claim 1, wherein the rigid top panel layer is configured to interlock with a tabulator apparatus.

10. The apparatus of claim 1, wherein the rigid top panel layer includes a hinged locking plate configured to interlock with a tabulator apparatus.

11. The apparatus of claim 1, wherein the rigid top panel layer comprises a metal plate extending between the first and second walls.

12. The apparatus of claim 1, wherein the rigid top panel layer is riveted to a top surface of the flexible top panel layer.

13. The apparatus of claim 1, further comprising upward-extending flanges around at least a portion of a perimeter of the rigid top panel layer.

14. A method of setting up a ballot box comprising:
separating a first side wall and a second side wall of a ballot box to expand the ballot box from a collapsed configuration to an expanded configuration in which a collapsible front panel, a collapsible rear panel, and a collapsible bottom panel extend between corresponding edges of the first and second side walls;
releasably securing a top panel across a top perimeter between top edges of the first and second side walls and of the front and rear panels, wherein the top panel includes a flexible top panel layer and a rigid top panel layer secured to the flexible top panel layer; and
positioning the rigid top panel layer to rest on top of the first and second side walls.

15. The method of claim 14, further comprising positioning flanges of the rigid top layer to laterally engage the first and second side walls.

16. The method of claim 14, wherein the flexible top panel layer is releasably secured across the top perimeter using a zipper.

17. The method of claim 14, further comprising deploying a ballot bag in the ballot box.

18. The method of claim 17, further comprising securing the ballot bag inside the ballot box using at least one strip of hook-and-loop fastener.

19. The method of claim 14, further comprising affixing a tabulator apparatus to the rigid top panel layer.

20. The method of claim 18, wherein the rigid top panel layer includes a hinged locking plate, and wherein affixing the tabulator apparatus comprises interlocking the tabulator apparatus with the hinged locking plate.

21. The method of claim 18, wherein the top panel includes an aperture, the tabulator incudes at least one tab on a bottom surface thereof, and affixing the tabulator comprises engaging the tab in the aperture.
